(19) United States
(12) Patent Application Publication
(10) Pub. No.: US 2007/0255567 A1
(43) Pub. Date: Nov. 1, 2007

(54) SYSTEM AND METHOD FOR GENERATING A PRONUNCIATION DICTIONARY

(75) Inventors: Srinivas Bangalore, Morristown, NJ (US); David Eugene Schulz, Wauwatosa, WI (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/380,496

(22) Filed: Apr. 27, 2006

(51) Int. Cl. G10L 13/08; G10L 13/00

(52) U.S. Cl. 704/260

(57) ABSTRACT

Disclosed is a system, method and computer-readable medium that stores instructions for controlling a computing device. The method embodiment relates to processing speech data wherein the method comprises generating phoneme transcriptions for words in a first language, generating a pronunciation dictionary comprising three-parts including, for each word in the dictionary, a first part having a first language orthography, a second part having a second language pronunciation and a third part having a second language orthography and applying the pronunciation dictionary in a speech application. The method is especially applicable to languages where the alphabet does not fully represent how a word is pronounced, as in Arabic or Hebrew.

### BACKGROUND OF THE INVENTION

1. Field of the Invention

The present invention relates to a system and method of processing speech data and more specifically a system and method for generating a pronunciation dictionary and applying the dictionary to speech applications.

2. Introduction

In automatic speech recognition (ASR) and other language applications, foreign names are difficult to process. For example, if one lived in an Arabic country, then Arabic names would be considered domestic. In this context, non-Arabic names (foreign names) present problems when designing and implementing a spoken dialog system. Modern Standard Arabic, the language used for writing and formal speech by all Arabs, has only three long and three short vowels (a,i,u,aa iy,uw). Typically, short vowels are rarely written in newspapers or books, except for religious books, such as the Quran or grammar books for children. This does not present a problem for Arabic speakers, except for foreign names. When foreign names are written in Arabic script, the short vowels are never written. Moreover, foreign names don't follow Arabic sound patterns. The result is that they are very difficult to pronounce, even for highly-educated native speakers. As an example of the extent of the mismatch between alphabets consider this: Arabic has 6 vowels, of which only three are normally written. English has at least 14 vowel phonemes. English names/words that are written in Arabic must collapse these 14 vowels into just three letters, or no letter at all. The English name “Bill” may be writing “bl” or “byl” in Arabic (where /y/ represents the long vowel /i/, as in “heel”). In the other direction, the Arabic word “bwt” would normally be used to write the following English words: “boot”, “boat”, “bout”, “pout”, and probably “poet”.

Given this mismatch it is not surprising that different news broadcasters may pronounce the same word many different ways. For example, in recordings taken from the Voice of America Arabic service, the Arabic orthography “jwnj” (Kim Dai-Jung the Nobel prize laureate) is pronounced at least four different ways by professional broadcasters.

When training language models for ASR, it is essential to know how each written word is pronounced. Native Arabic words have a relatively small set of possible pronunciations that can be looked up in dictionaries or derived. With non-native words the problem is much more difficult. Given that many foreign names are long, with 4, 5, 6 or more consonants and the possibility of three different vowels, or possibly no vowel, between each consonant, we see that a 4 consonant word has 192 (3 times 4) possibilities (you have to have at least one vowel in a word), a word with 5 consonants has 768 possibilities, and a word with 6 consonants could be pronounced 3972 different ways.

In addition, three of the letters (alif, waw and ya), which usually are used to represent long vowels, are often pronounced as short vowels. The challenge identified above may also apply to other languages such as Hebrew. A good Arabic to phoneme pronouncing dictionary for foreign (non-Arabic) names and other foreign words would be of significant value to Speech Recognition and Text-to-Speech work in Arabic. Thus, what is needed in the art is an improved phoneme pronunciation dictionary for names and/or words in a foreign language from a domestic language.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention relates to a system, method and computer-readable medium that stores instructions for controlling a computing device. The method embodiment relates to processing speech data and comprises generating phoneme transcriptions for words in a first language, generating a three part pronunciation dictionary having a first part with a first language orthography, a second part having a second language pronunciation and a third part having a second language orthography and applying the pronunciation dictionary in a speech application.

The method is especially applicable to languages where the alphabet does not fully represent how a word is pronounced, as in Arabic or Hebrew. One aspect of the invention involves, given a pronunciation, automatically transliterating it by rule into a very small number of plausible Arabic variants. Doing the problem in reverse, a given Arabic orthographic string may have several hundred or more plausible pronunciations. In this way, given a phoneme string, the inventors can create an Arabic-to-phoneme dictionary by starting with the phonemes and working backwards. Once this dictionary is built, the system can use it to constrain the possible ways a foreign word is pronounced, or to predict how the Arabic spelling of a foreign name will actually be pronounced.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates the basic spoken dialog system;

FIG. 2 illustrates an exemplary system; and

FIG. 3 illustrates a method embodiment of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

As introduced above, the invention may be in one of many embodiments, including, but not limited to, a system or computing device, a method and a computer-readable medium. The system embodiment may include any hardware component, computer system (whether a server, desktop, mobile device, cluster, grid, etc), or computing device. Those of skill in the art will understand that there are many devices that have the basic components for computing such as a processor, memory, a hard disk or other data storage means, and so forth. The system may comprise a plurality of computing devices communicating wirelessly or via a wired network. There is no restriction on the type of hardware, firmware or other computing components that may be combined to perform the speech processing functionality disclosed herein. The system will typically function by processing computing instructions programmed in modules in any programming language that is convenient for a particular instance and known to those of skill in the art.

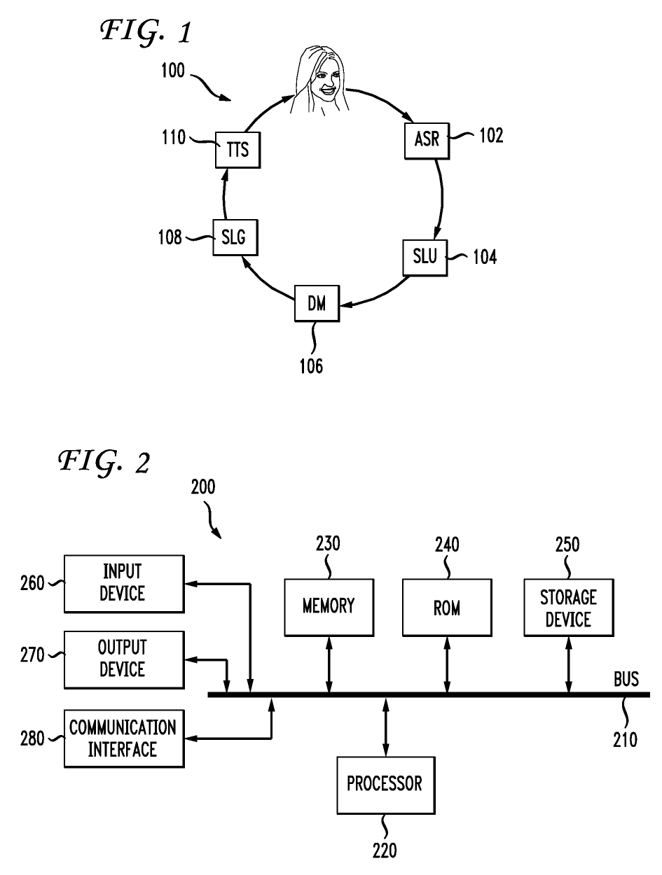

Spoken dialog systems aim to identify intents of humans, expressed in natural language, and take actions accordingly, to satisfy their requests. FIG. 1 is a functional block diagram of an exemplary natural language spoken dialog system 100. Natural language spoken dialog system 100 may include an automatic speech recognition (ASR) module 102, a spoken language understanding (SLU) module 104, a dialog management (DM module 106, a spoken language generation (SLG) module 108, and a text-to-speech (TTS) module 110. The present invention focuses on innovations related to the dialog management module 106 and may also relate to other components of the dialog system.

ASR module 102 may analyze speech input and may provide a transcription of the speech input as output. SLU module 104 may receive the transcribed input and may use a natural language understanding model to analyze the group of words that are included in the transcribed input to derive a meaning from the input. The role of DM module 106 is to interact in a natural way and help the user to achieve the task that the system is designed to support. DM module 106 may receive the meaning of the speech input from SLU module 104 and may determine an action, such as, for example, providing a response, based on the input. SLG module 108 may generate a transcription of one or more words in response to the action provided by DM 106. TTS module 110 may receive the transcription as input and may provide generated audible speech as output based on the transcribed speech.

Thus, the modules of system 100 may recognize speech input, such as speech utterances, may transcribe the speech input, may identify (or understand) the meaning of the transcribed speech, may determine an appropriate response to the speech input, may generate text of the appropriate response and from that text, may generate audible “speech” from system 100, which the user then hears. In this manner, the user can carry on a natural language dialog with system 100. Those of ordinary skill in the art will understand the programming languages and means for generating and training ASR module 102 or any of the other modules in the spoken dialog system. Further, the modules of system 100 may operate independent of a full dialog system. For example, a computing device such as a smartphone (or any processing device having a phone capability) may have an ASR module wherein a user may say “call mom” and the smartphone may act on the instruction without a “spoken dialog.”

FIG. 2 illustrates an exemplary processing system 200 in which one or more of the modules of system 100 may be implemented. Other modules configured to perform steps according to the invention may be processed on this or a similar system. Thus, system 100 may include at least one processing system, such as, for example, exemplary processing system 200. System 200 may include a bus 210, a processor 220, a memory 230, a read only memory (ROM) 240, a storage device 250, an input device 260, an output device 270, and a communication interface 280. Bus 210 may permit communication among the components of system 200. Where the inventions disclosed herein relate to the TTS voice, the output device may include a speaker that generates the audible sound representing the computer-synthesized speech.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to system 200, such as a keyboard, a mouse, a pen, motion input, a voice recognition device, etc. Output device 270 may include one or more conventional mechanisms that output information to the user, including a display, a printer, one or more speakers, or a medium, such as a memory, or a magnetic or optical disk and a corresponding disk drive. Communication interface 280 may include any transceiver-like mechanism that enables system 200 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of natural spoken dialog system 100, communication interface 280 may not be included in processing system 200 when natural spoken dialog system 100 is implemented completely within a single processing system 200.

System 200 may perform such functions in response to processor 220 executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

The invention preferably comprises two parts. First, the invention involves generating a database having three parts or three types of data that relate a first language to a second language. For example, a first language may be English and the second language may be Arabic. In this example, a first part may comprise an English orthography of a word or name, a second part may comprise the Arabic pronunciation of the word or name and a third part may comprise an Arabic orthography of the word of phrase. This is preferably accomplished by working backwards, first by collecting millions of names written in the second language Latin, in this example) alphabet, then using text-to-speech and name-pronouncing software to generate phonemic transcriptions for these names, then transliterating the phonemic transcriptions into the first language (Arabic letters) using well-understood rules.

The following will illustrate the database. Using the example of two languages being Arabic and English, the dictionary has three parts: Arabic orthography / Arabic Pronunciation / English orthography /. For example:

jwnz / j uw n z / Jones
jwnz / j uw n z / Joans
jwnz / j uw n a z / Jonahs
jwnz / j uw n z / Johns
jwnz / j uw n z / Junes

Using the backwards method, one would find that “Jones” in the first language is pronounced “j o n z” in the second language. The letters /j/,/n/, and /z/, all have Arabic equivalents, the sound /o/ must be written as a /u/ in Arabic (uw). As for “Jonahs”, the phonemes are “j o n a z”. Here the short /a/ probably would not be written in Arabic. The phonemes for “Johns” are /j/ /a/ /n/ /z/. In this case one could write it in Arabic either as “jnz”, “jAnz” or “jwnz”. Most people who know English would probably write it as “jwnz”, since this corresponds most closely to the English letter ‘o’. Lastly, “Junes” is phonemically /j/ /u/ /n/ /z/, so the only way to write this in Arabic is “jwnz”.

The three-part dictionary above instructs us that there are five different Latin names that could be represented by the Arabic spelling “jwnz”, but there are only two different ways to pronounce them in the second language of Arabic.

It is understood that in the examples discussed herein, that Arabic and Latin are used as the respective first and second languages. However, any two languages may be utilized in the process of generating the pronunciation dictionary. This technique will work for any pairs of languages which use different alphabets. For example, if one language is English, then this technique would probably work well with Arabic, Hebrew, Hindi, Japanese, Korean, etc. All of these languages have non-Latin alphabets or syllabaries.

After this dictionary has been constructed, standard techniques can be used to generate Arabic letter-to-sound rules to handle foreign names written in Arabic but that are not in the name exception dictionary. In one aspect of the invention, a stochastic language-of-origin classifier can be created for some Arabic spellings. This will work well for longer words, but it may have important benefits, for example for data mining applications.

It is a difficult and mostly unsolved problem to determine the pronunciation of a string of Arabic letters representing a spelling of a foreign word. The goal of building a good dictionary, or even better, a good dictionary supplemented by Arabic letter-to-sound rules for foreign words, seems to require many person-years of manual effort. The invention addresses this difficulty by constructing such a dictionary “backwards”. First of all, transliterating a word into Arabic, given a pronunciation, is straightforward. For any given pronunciation, there usually are only a few plausible ways to write the word in Arabic. Since Arabic has only three vowels, vowels that don't occur in Arabic are typically mapped to the closest Arabic vowel. For example, a long /o/ in English (as in “boat”) would be mapped to “uw” in Arabic, sounding like “boot”. Arabic has no /p/, so /p/ is typically written as /b/ or /f/, and so on.

An important aspect of making this workable is that given a pronunciation, the system can automatically transliterate it by rule into a very small number of plausible Arabic variants. Recall that doing the problem in reverse, a given Arabic orthographic string may have several hundred or more plausible pronunciations. In this way, given a phoneme string, the system can create an Arabic-to-phoneme dictionary by starting with the phonemes and working backwards. Once this dictionary is built, the system uses it to constrain the possible ways a foreign word is pronounced, or to predict how the Arabic spelling of a foreign name will actually be pronounced.

It is straightforward to construct a dictionary containing millions of names from all around the world. In English, and in most European languages, names are capitalized, and methods already exist for extracting names from online text sources. The inventors also utilize a name database with millions of entries. By combining existing name databases with new names mined from online sources, many millions of names can be collected. There are several excellent name pronouncing programs available, usually part of text-to-speech systems. In addition, AT&T has a name pronouncing program that first determines language of origin, then generates an appropriate pronunciation based on the presumed language of origin (for example different rules apply for names of French origin than for names of Slavic origin).

Using these name pronouncing programs, with suitable adjustments to conform to Arabic phonology and orthographic conventions, the inventors generated an Arabic-to-phoneme dictionary for millions of foreign names by mapping the phonemes to Arabic orthography. This dictionary can be in the form of a database that contains an Arabic orthographic string, one or more pronunciation variants, and also the Latin-alphabet spelling of the name. In this way, the same dictionary/database can be used for Machine Translation.

Lastly, once such a database has been constructed, it is now possible to use it to train Arabic letter to sound rules based upon it. Previous work in training Arabic to English pronunciation rules, or Arabic to English Spelling rules (e.g. converting “dfyd” in Arabic to “David” in English) has always been based on small, hand-constructed, corpora. When analyzing text, the letter-to-spelling (“LTS”) rules can be used to predict a pronunciation for new words that have never been seen before. This is a key feature, since names in the news are constantly changing.

Once this dictionary and LTS rules have been created as described, the following procedure would be used for determining how to pronounce a given word written in Arabic script: 1) Look up the word in an Arabic dictionary; 2) if that fails, try to analyze the word using a morphological analyzer. There are several morphological analyzers available for Arabic. They decompose the orthography into stems and affixes and attempt to construct the word from a dictionary and standard affixation rules; 3) if that fails, look in the Arabic foreign name dictionary described above; 4) if that fails, apply the Arabic foreign-word letter to sound rules to predict the pronunciation (and/or spelling in Latin script). In current Arabic Broadcast News systems, ASR accuracy is about half as good as the accuracy of ASR systems for English Broadcast News. One reason for this is an exceptionally large number of words in both the training corpora and in the spoken newscasts are “out of vocabulary”.

This invention should greatly reduce the out of vocabulary rate, and moreover, it should produce better ASR dictionaries than other methods (some Arabic letter to sound systems exist today, but they have not been trained on enough of the right kinds of data to be very good).

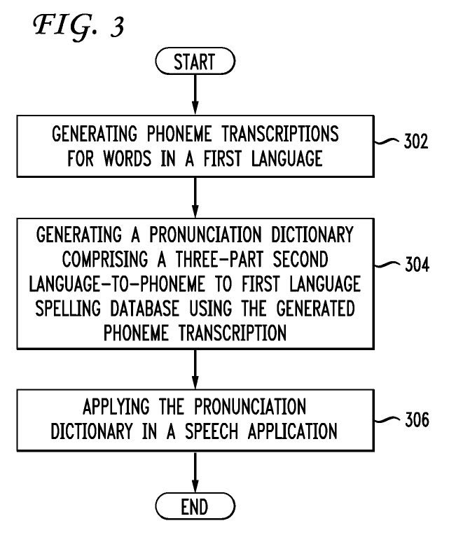

The method embodiment of the invention is shown in FIG. 3. This figure shows generating phoneme transcriptions for words in a first language (302), generating a pronunciation dictionary comprising a three-part second language-to-phoneme to first language spelling database using the generated phoneme transcription (304) and applying the pronunciation dictionary in a speech application (306).

The invention is well suited for generating a pronunciation dictionary or database for foreign (non-Arabic) names that are spelled in Arabic. The mapping of Arabic spellings to their Latin equivalents provides support for Machine Translation tasks. The training of Arabic letter-to-sound rules for foreign names on a very large corpus of accurate name pronunciations is also important to the process.

Others have worked on the same problem, but have failed to discover this “backwards” approach. The previous work that has been done on this problem always worked from Arabic to English. However, the previous approach is to predict English pronunciation or orthography by rule from Arabic orthography. Two good papers on the subject are: “Machine Transliteration of Names in Arabic Text” (Y. Al-Onaizan and K. Knight), Proc. of ACL Workshop on Computational Approaches to Semitic Languages, 2002, and “Translating Names and Technical Terms in Arabic Text,” (B. Stalls and K. Knight), Proc of the COLING/ACL Workshop on Computational Approaches to Semitic Languages, 1998, incorporated herein by reference.

One could create such a dictionary by hand, but it would require thousands or tens of thousands of person-hours. It might be possible to use parallel translations to match Arabic spellings with Latin spellings, however, this technique is limited to those names in the parallel texts. The proposed technique works without requiring parallel texts. This technique may also work for Hebrew or any other language where the alphabet does not fully represent how a word is pronounced. Most Semitic languages are do not write short vowels. The approach described herein also applies to other processing techniques and any aspect of speech processing. For example, this technique is adaptable for Machine Translation and speech recognition tasks. Furthermore, this technique may be applied to any speech processing step, such as text-to-speech, dialog management, speech recognition, and so forth.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, any languages may be utilized as a first language and a second language, not just Arabic and Latin. Accordingly, the appended claims and their legal equivalents should only define the invention, rather than any specific examples given.

We claim:

1. A method of processing speech data, the method comprising:
generating phoneme transcriptions for words in a first language;
generating a pronunciation dictionary comprising three-parts including, for each word in the dictionary, a first part having a first language orthography, a second part having a second language pronunciation and a third part having a second language orthography; and
applying the pronunciation dictionary in a speech application.

2. The method of claim 1, wherein generating the pronunciation dictionary further comprises:
collecting names written in the first language alphabet;
using text-to-speech and name pronunciation software to generate phoneme transcriptions of the names; and
transliterating the phoneme transcriptions into the second language using rules.

3. The method of claim 1, wherein applying the pronunciation dictionary in a speech application comprises at least one of: using the pronunciation dictionary to constrain possible ways a first language word is pronounced and predicting how a second language spelling of first language name will be pronounced.

4. The method of claim 1, wherein the second language is one of Arabic or Hebrew and the first language is one of Latin or English.

5. The method of claim 1, wherein the three-part dictionary comprises a database containing a second language orthographic string, at least one pronunciation variant, and the first-language spelling.

6. The method of claim 1, further comprising:
using the pronunciation dictionary to train second language letter-to-sound rules.

7. The method of claim 6, further comprising:
analyzing text using the trained letter-to-sound rules to predict a pronunciation for new words not seen before.

8. The method of claim 2, wherein the step of transliterating the phoneme transcriptions into the second language using rules further comprises transliterating the phoneme transcriptions by rule into a number of plausible variants in the second language.

9. A system for processing speech data, the system comprising:
a module configured to generate phoneme transcriptions for words in a first language;
a module configured to generate a pronunciation dictionary comprising three-parts including, for each word in the dictionary, a first part having a first language orthography, a second part having a second language pronunciation and a third part having a second language orthography; and
a module configured to apply the pronunciation dictionary in a speech application.

10. The system of claim 9, wherein the module configured to generate the pronunciation dictionary further:
collects names written in the first language alphabet;
uses text-to-speech and name pronunciation software to generate phoneme transcriptions of the names; and
transliterates the phoneme transcriptions into the second language using rules.

11. The system of claim 9, wherein the module configured to apply the pronunciation dictionary in a speech application further: uses the pronunciation dictionary to constrain possible ways a first language word is pronounced or predicts how a second language spelling of first language name will be pronounced.

12. The system of claim 9, wherein the second language is one of Arabic or Hebrew and the first language is one of Latin or English.

13. The system of claim 9, wherein the three-part dictionary comprises a database containing a second language orthographic string, at least one pronunciation variant, and the first-language spelling.

14. The system of claim 9, further comprising:
a module configured to use the pronunciation dictionary to train second language letter-to-sound rules.

15. The system of claim 14, further comprising:
a module configured to analyze text using the trained letter-to-sound rules to predict a pronunciation for new words not seen before.

16. The system of claim 10, wherein the module configured to transliterate the phoneme transcriptions into the second language using rules further transliterates the phoneme transcriptions by rule into a number of plausible variants in the second language.

17. A computer-readable medium storing instructions for controlling a computing device to process speech data, the instructions comprising:
generating phoneme transcriptions for words in a first language;
generating a pronunciation dictionary comprising three-parts including, for each word in the dictionary, a first part having a first language orthography, a second part having a second language pronunciation and a third part having a second language orthography; and
applying the pronunciation dictionary in a speech application.

18. The computer-readable medium of claim 17, wherein generating the pronunciation dictionary further comprises:
collecting names written in the first language alphabet;
using text-to-speech and name pronunciation software to generate phoneme transcriptions of the names; and
transliterating the phoneme transcriptions into the second language using rules.

19. The computer-readable medium of claim 17, wherein applying the pronunciation dictionary in a speech application comprises at least one of: using the pronunciation dictionary to constrain possible ways a first language word is pronounced and predicting how a second language spelling of first language name will be pronounced.

20. The computer-readable medium of claim 17, wherein the three-part dictionary comprises a database containing a second language orthographic string, at least one pronunciation variant, and the first-language spelling.

21. The computer-readable medium of claim 17, the instructions further comprising:
using the pronunciation dictionary to train second language letter-to-sound rules.

22. The computer-readable medium of claim 21, the instructions further comprising:
analyzing text using the trained letter-to-sound rules to predict a pronunciation for new words not seen before.

23. The computer-readable medium of claim 18, wherein the step of transliterating the phoneme transcriptions into the second language using rules further comprises transliterating the phoneme transcriptions by rule into a number of plausible variants in the second language.
